(19) United States
(12) Patent Application Publication
(10) Pub. No.: US 2007/0223455 A1
(43) Pub. Date: Sep. 27, 2007

(54) Method of switching between VoIP call and traditional call

(75) Inventors: Chieh Chang, Fremont, CA (US); Wi-Sheng Ou Yang, Taipei City (TW); Kuan-Hsi Chen, Hsinchu City (TW); Lun-Chieh Lo, Toufen Township (TW)

Correspondence Address: BACON & THOMAS, PLLC, 625 SLATERS LANE, FOURTH FLOOR, ALEXANDRIA, VA, 22314, US

(73) Assignee: F3 Incorporation, Hsinchu (TW)

(21) Appl. No.: 11/501,803

(22) Filed: Aug. 10, 2006

(30) Foreign Application Priority Data
Mar. 27, 2006 (TW) 095110547

(51) Int. Cl. H04L 12/66

(52) U.S. Cl. 370/352

(57) ABSTRACT

A method of switching between a VoIP call and a traditional call, involving the use of a caller terminal, a call box device, a first computer device, a second computer device, and a receiver terminal. A VoIP connection has to be established before the caller terminal and the receiver terminal can engage in a VoIP call. If the VoIP connection is successfully established, a computer device electrically connected to the caller terminal monitors the Internet quality between the caller terminal and the receiver terminal. If the Internet quality is poor, upon the pressing of a predetermined key, the caller terminal alternatively connects to the receiver terminal via a PSTN call through the switching of the call box device, which is electrically connected to the receiver terminal.

### BACKGROUND OF THE INVENTION

1. Field of the Invention

The present invention relates to VoIP telephony and, more particularly, to a method of switching between a VoIP call and a traditional call.

2. Description of Related Art

FIG. 1 shows illustration of a typical IP phone system, which includes computer devices 11 and 13, and an Internet 12. Computer devices 11 and 12 are both connected to Internet 12. Computer device 11 is electrically connected to an earphone 111 and a microphone 112; computer device 13 is electrically connected to an earphone 131 and a microphone 132. Computer device is further equipped with an Internet communications software, such as an instant messenger Skype.

Since voice is transmitted as packets over the Internet, and any packet lost due to poor Internet connectivity can lead to a poor voice transmission, the quality of Internet connection has a determining factor on the quality of a VoIP call, such as one made by a user (A1) on computer device 11 to another user (A2) on computer device 13.

Despite saving user substantial calling fees, a poor VoIP connection due to poor Internet quality can be a great nuisance and inconvenience, especially during the placement of an important call. Current solution to this poor connectivity issue involves disconnecting the current call and redialing. However such brute force method often proves to be futile against poor Internet quality.

Thus, given that voices in traditional calls are often transmitted via a PSTN (Public Switched Telephone Network), and the quality of calls made over PSTN is generally superior to that made over IP (Internet Protocol), it is desirable to provide a method to switch a call between traditional telephony and VoIP telephony in response to Internet quality so as to better improve calling experience.

### SUMMARY OF THE INVENTION

It is an object of the present invention to provide a method of switching between a VoIP call and a traditional call, such that a user does not need to memorize many complicated phone numbers.

It is another object of the present invention to provide a method of switching between a VoIP call and a traditional call, such that operation is simplified without having a user to manually dial.

It is still another object of the present invention to provide a method of switching between a VoIP call and a traditional call, such that a user can converse with another user using alternative communications means with the pressing of a predetermined phone key.

It is yet another object of the present invention to provide a method of switching between a VoIP call and a traditional call, such that a user can use a traditional phone to place a traditional call and be switched back to the VoIP call with the pressing of a predetermined phone key after the Internet quality returns to a good condition, thereby reducing phone costs.

To achieve the objects, a method of switching between a VoIP call and a traditional call is provided. The method is applied between a caller terminal and a receiver terminal. The caller terminal is electrically connected with a call box device. The call box device is electrically connected with a first computer device. The receiver is electrically connected with a second computer device. Both the first computer device and the second computer device are connected to the Internet. The method of switching begins by first establishing a VoIP connection between the caller terminal and the receiver terminal. Next, if the VoIP connection is successfully established between the caller terminal and the receiver terminal, the quality of Internet connection is monitored between the caller terminal and the receiver terminal. If the quality of Internet connection between the caller terminal and the receiver terminal is detected to be poor, the caller terminal is switched by the call box device after a first predetermined key is pressed on the caller terminal, such that the caller terminal and the receiver terminal engage in a call via PSTN. Then, if the quality of Internet connection between the caller terminal and the receiver terminal returns to a good condition, the caller terminal is switched by the call box device after a second predetermined key is pressed on the caller terminal, such that the call is resumed between the caller terminal and the receiver terminal via the VoIP connection.

Other objects, advantages, and novel features of the invention will become more apparent from the following detailed description when taken in conjunction with the accompanying drawings.

### BRIEF DESCRIPTION OF THE DRAWINGS

FIG. 1 shows illustration of an archetypical VoIP phone system;

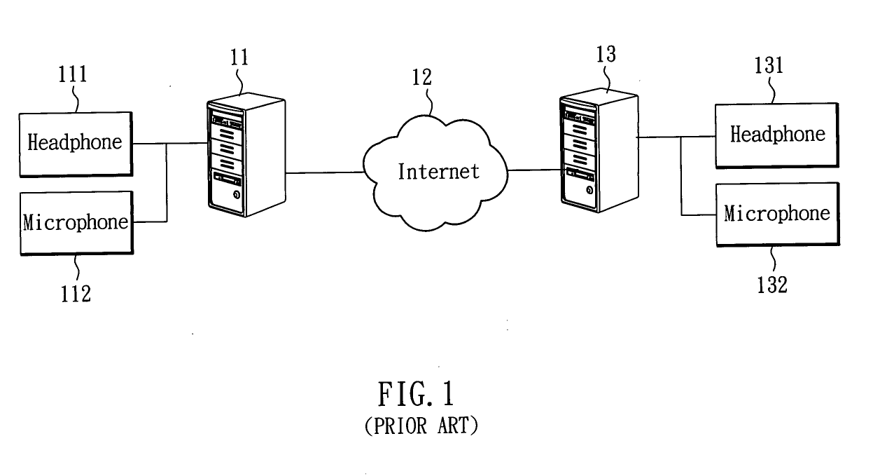

FIG. 2 shows illustration of a caller terminal and a receiver terminal engaged in a VoIP call according to a first preferred embodiment of the invention;

FIG. 3 shows illustration of the interior of a call box device according to the first embodiment of the invention;

FIG. 4 is an action flow diagram of the first embodiment of the invention;

FIG. 5 shows illustration of the call box device switching to PSTN according to the first preferred embodiment of the invention;

FIG. 6 shows illustration of the caller terminal engaged in a call with the receiver terminal via PSTN according to the first preferred embodiment of the invention;

FIG. 7 shows illustration of the call box device switching back to the VoIP call according to the first preferred embodiment of the invention;

FIG. 8 shows illustration of the caller terminal resuming the VoIP call with the receiver terminal according to the first preferred embodiment of the invention;

FIG. 9 shows illustration of a caller terminal and a receiver terminal engaged in a VoIP call according to a second preferred embodiment of the invention;

FIG. 10 shows illustration of the caller terminal engaged in a call with the receiver terminal first via Internet and then the PSTN of the receiver terminal according to the second preferred embodiment of the invention;

FIG. 11 shows illustration of the caller terminal resuming the VoIP call with the receiver terminal according to the second preferred embodiment of the invention; and

FIG. 12 shows illustration of the caller terminal engaged in a call with the receiver terminal via PSTN according to the second preferred embodiment of the invention.

FIG. 13 shows illustration of the call terminal resuming the VoIP call with the receiver terminal after terminating the PSTN call.

### DETAILED DESCRIPTION OF THE PREFERRED EMBODIMENT

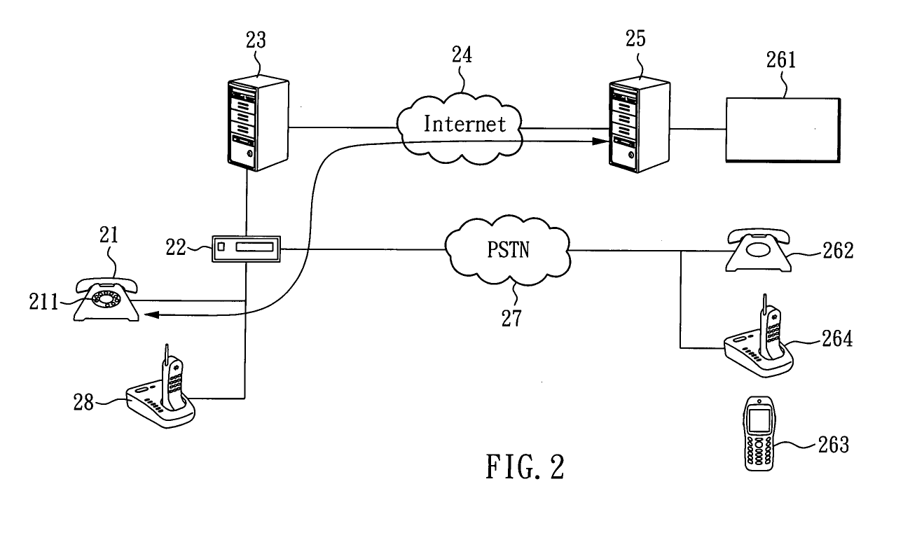

FIG. 2 shows illustration of the placement of a call under normal call quality according to a first preferred embodiment of the invention.

FIG. 2 is shown to include caller terminals 21 and 28, a call box device 22, computer devices 23 and 25, an Internet 24, receiver terminals 261, 262, 263, and 264, and PSTN 27.

Caller terminals 21 and 28 are electrically connected to call box device 22. Call box device 22 is electrically connected to computer device 23 and PSTN 27. Receiver terminal 261 is electrically connected to computer device 25 directly. Receiver terminal 262 and 264 are both electrically connected to PSTN 27. Receiver terminal 263 can establish electrical connection with PSTN 27 via a communications network. Computer devices 23 and 25 are both connected to Internet 24.

In this embodiment of the invention, caller terminal 21 is a traditional phone. Receiver terminal 261 is an earphone with microphone kit. Receiver terminal 262 is a traditional phone. Receiver terminal 263 is a mobile phone. Receiver terminal 264 is an indoor cordless phone. In other embodiments, receiver terminal 261 can be an IP phone, such as a Skype phone.

Call box device 22 is electrically connected to caller terminals 21 and 28, computer device 23, and PSTN 27 respectively, such that caller terminals 21 and 28 can establish a call with remote end of PSTN 27 via call box device 22. Caller terminals 21 and 28 can also make a VoIP call via call box device 22, computer device 23, and Internet 24.

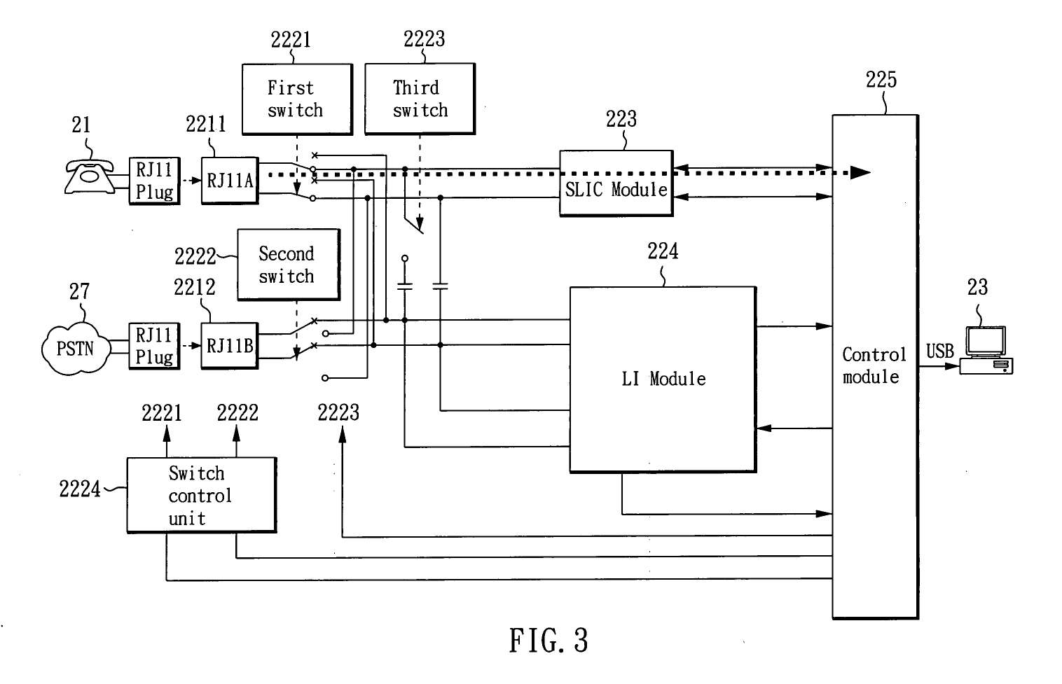

FIG. 3 shows illustration of the schematics of call box device 22. For better illustration, FIG. 3 only shows the connections of caller terminal 21, call box device 22, computer device 23, and PSTN 27. Call box device 22 shown in FIG. 3 includes phone line sockets 2211 and 2212, a first switch 2221, a second switch 2222, a third switch 2223, a switch control unit 2224, a SLIC (Subscriber Line Interface Circuit) module 223, a LI (Line Interface) circuit module 224, and a control module 225.

Phone line sockets 2211 is electrically connected to caller terminal 21, and phone cable 2212 is electrically connected to PSTN 27. Also, call box device 22 is electrically connected to computer device 23 via a USB (Universal Serial Bus) interface. In other embodiments, call box device 22 can also be electrically connected to computer device 23 via other transmission interfaces, such as IEEE 1394.

In addition, first switch 2221, second switch 2222, third switch 2223, and switch control unit 2224 are collectively used for switching the connections among phone line sockets 2211 and 2212, SLIC module 223, and LI module 224. Control module 225 is electrically connected to SLIC module 223, LI module 224, and switch control unit 2224 respectively. Control module 225 and switch control unit 2224 can control the operation of the switches 2221, 2222 and 2223.

SLIC module 223 simulates the functions of a central office by providing power feed, voltage detection, audio transmission and reception, ringing generation, caller ID, and call progress tone etc. LI module 224 is comprised of a number of elements. For instance, LI module 224 can include protection and rectifier unit, phone line status detection unit, ring tone detection unit, and off-hook emulation unit, the capabilities of which in combination with SLIC module 223 allow the call box device 22 to make both traditional and VoIP calls. In addition to controlling the operation of SLIC module 223, LI module 224 and switch control unit 2224, control module 225 can be used to transmit and receive data. For instance, control module 225 can convert audio signals into data in USB transmission format.

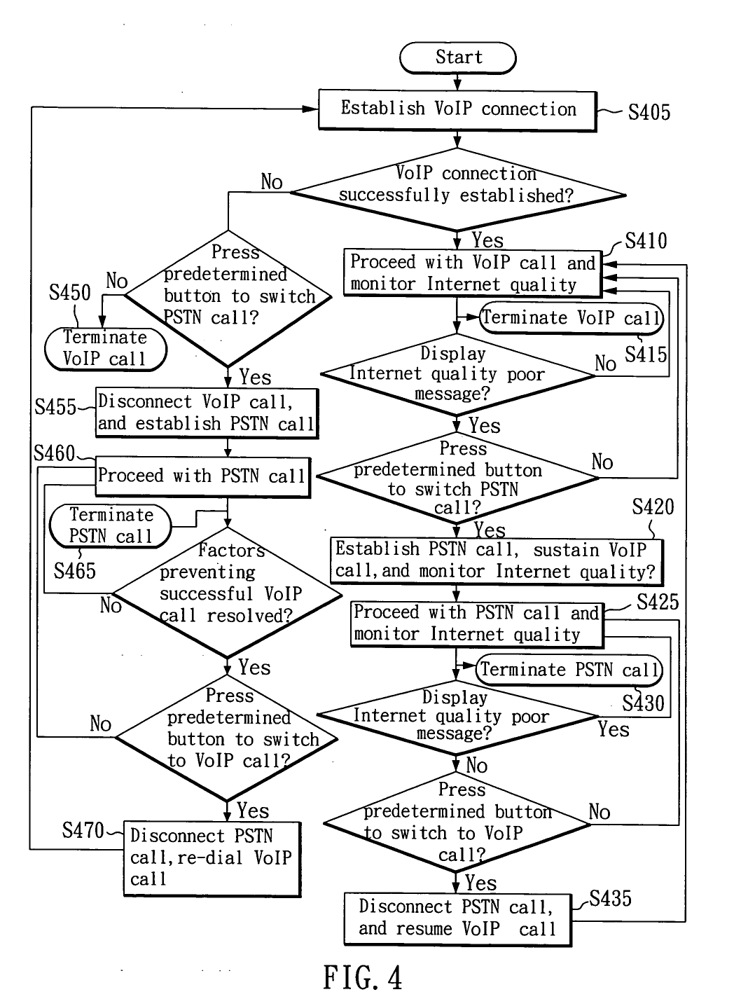

FIG. 4 shows flow diagram of the first embodiment of the invention. FIGS. 2 and 3 should also be referred for better illustration. In this embodiment, user U1 located in Taipei wishes to make a call with user U2 located in New York. User U1 can decide on using caller terminal 21 or caller terminal 28 to make the call. Caller terminal 21, 28 and computer device 23 are all connected to call box device 22, which is electrically connected to PSTN 27. Receiver terminal 261 used by user U2 is a typical earphone with microphone kit that is directly and electrically connected to computer device 25.

To establish a VoIP call with user U2, user U1 must utilize caller terminal 21 or 28, call box device 22, computer device 23, and the Internet communications software installed on computer device 23 collaboratively to communicate with the computer device 25 and its Internet communication software that user U2 operates on (step S405). Next, if a VoIP call is successfully established between caller terminal 21 and caller terminal 261 used by caller U1 and U2, respectively, then users U1 and U2 can thus engage in a VoIP conversation, and the Internet quality monitor program installed on computer device 23 is triggered to monitor the quality of Internet connection between the caller terminal 21 and the receiver terminal 261 (step S410).

The interconnections of the circuit blocks of call box device 22 at this time are as shown in FIG. 3. At this time, phone line socket 2211 and SLIC module 223 are electrically connected to each other. Phone line socket 2212 is not electrically connected to phone line socket 2211, and SLIC module 223 is not electrically connected to LI module 224.

If the quality of Internet connection between user U1 and U2 is good during the VoIP call, then the VoIP connection is terminated after users U1 and U2 are finished with the call (step S415). However, if the quality of Internet connection between users U1 and U2 is poor during the VoIP call, then computer device 23 can display a poor Internet quality message to inform user U1 of current Internet quality allowing user U1 to decide whether to switch to a traditional phone call (via PSTN). Conversely, computer device 23 does not display a poor Internet quality message if the quality of Internet connection is good, and users U1 and U2 can engage in the call normally (step S410) until the end of the call (step S415).

In this embodiment, “poor” Internet quality refers to the experience of voice delay, voice echo, babble, and loud background noise etc. when the caller terminal 21 converses with the receiver terminal 261.

After computer device 23 displays the poor Internet quality message, user U1 can selectively press a predetermined key on the caller terminal 21 so as to switch the current VoIP call to a PSTN call.

If user U1 presses the predetermined key 211 on caller terminal 21, then caller terminal 21 would establish connection with user U2 via PSTN 27 through the switching of call box device 22. At this time, caller terminal 21 can engage in a call with receiver terminal 262 (e.g. a traditional phone) via call box device 22. Caller terminal 21 can also engage in a call with receiver terminal 263 (e.g. a mobile phone) via call box device 22. Of course, at this time, the VoIP connection established between the computer device 23 and the computer device 25 is still sustained by call box device 22, and the quality of Internet connection between computer device 23 and the computer device 25 is continued to be monitored by the Internet quality monitor program on computer device 23 (step S420).

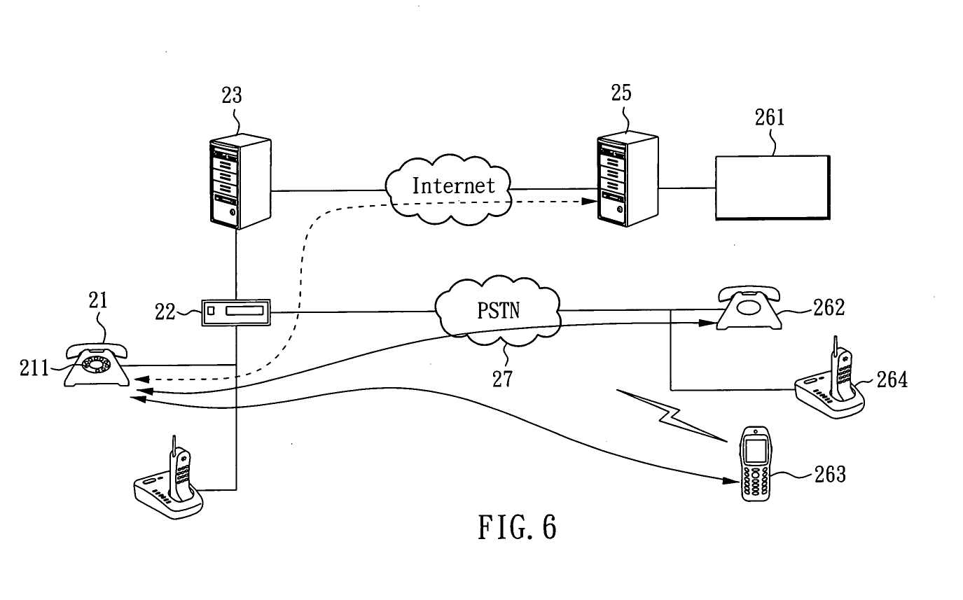

FIGS. 3, 5 and 6 should be referred for detailed illustration of step S420. When user U1 presses the predetermined key 211 on caller terminal 21, a DTMF (Dual-Tone Multi Frequency) signal is generated therefrom. In this embodiment, predetermined key 211 is the “*” key. In other embodiments, predetermined key 211 can be the “#” key, other keys, or keys in combination. The DTMF signal generated upon pressing the predetermined key 211 is then output to SLIC module 233 of call box device 22 such that SLIC module 233 outputs a control signal to control module 225. Control module 225 then controls switch control unit 2224 so as to switch first switch 2221, causing phone line socket 2211 to break electrical connection with SLIC module 223 and alternatively make electrical connection with phone line socket 2212. Also, control module 225 also controls the third switch 2232 such that SLIC module 223 makes electrical connection with LI module 224 and phone line socket 2212.

Since at this time the caller terminal 21 is already off hooked, the voltage at the PSTN drops due to the switching of first switch 2221. The status of phone is thus turned to a ready-for-dialing state, and a dial tone can be heard on the caller terminal 21. Then, computer device 23 transmits the local number (or mobile phone number) to SLIC module 223 via control module 225 of call box device 22. SLIC module 223 then dials the local number belonging to user U2 via PSTN 27 to establish a call. Preferably, the local number or mobile number is pre-stored on computer device 23.

Due to the switching connection of third switch 2223, SLIC module 223 can transform the local number of user U2 into DTMF signal, which can be transmitted to PSTN via a capacitor. Through such, user U1, without having to redial, can carry on conversation seamlessly with user U2 via PSTN 27 using caller terminal 21, while user U2 can utilize receiver terminal 262, receiver terminal 263, or receiver terminal 264 to answer the call. During this time, the VoIP connection established between caller terminal 21 and receiver terminal 261 is still sustained.

While users U1 and U2 are engaged in the call via PSTN, the Internet quality monitor program yet still monitors the quality of Internet connection between caller terminal 21 and receiver terminal 261. If the quality of Internet is still poor, then computer device 23 continues to display the Internet quality poor message, and users U1 and U2 continue conversation via PSTN until the PSTN call is terminated (step S430). If the quality of Internet returns to a good condition, however, then computer device 23 stops displaying the Internet quality poor message and user U1 can choose to either continue on with the current PSTN call (step S425), or alternatively press the predetermined key 211 such that call box device 22 switches the connection between user U1 and user U2 to a VoIP call (step S435).

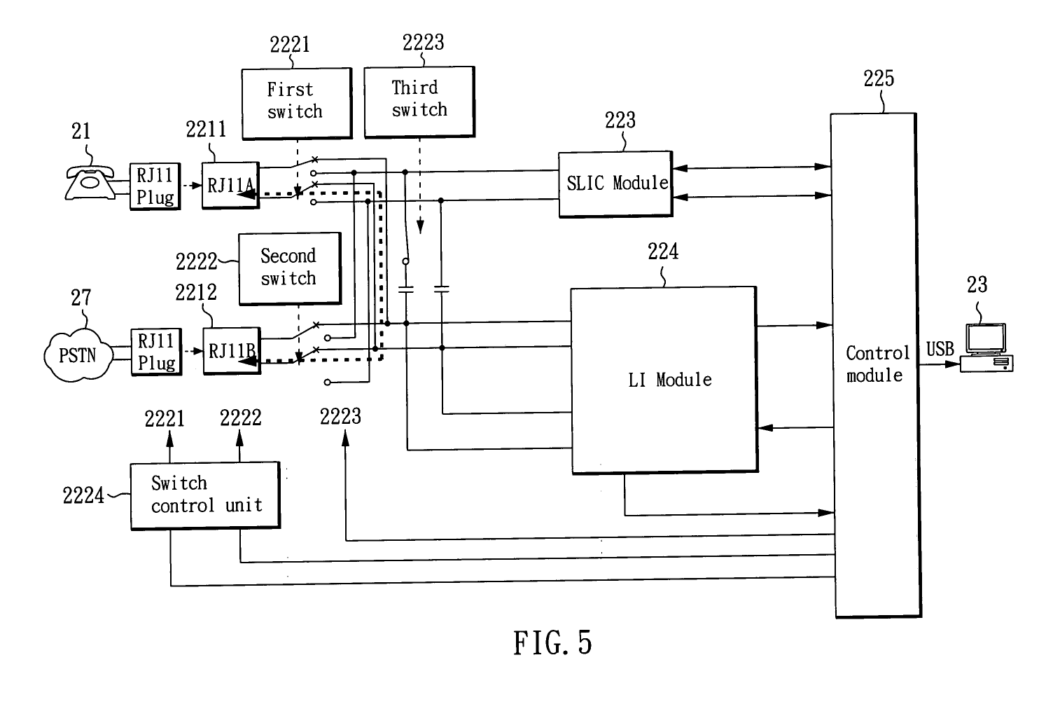

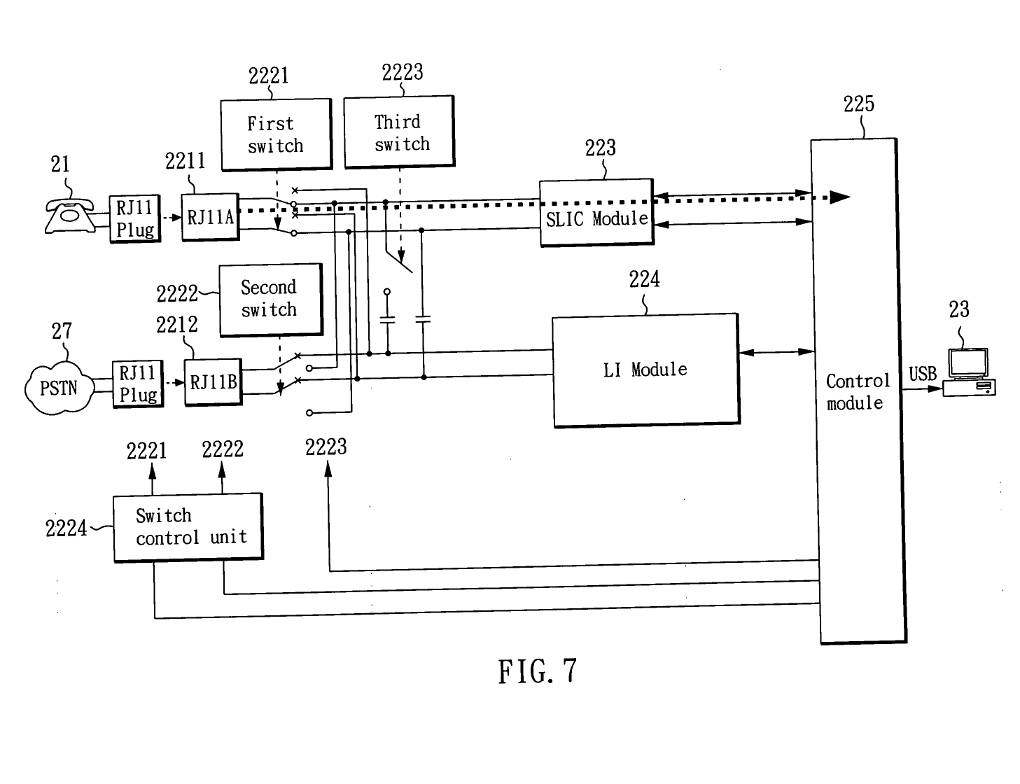

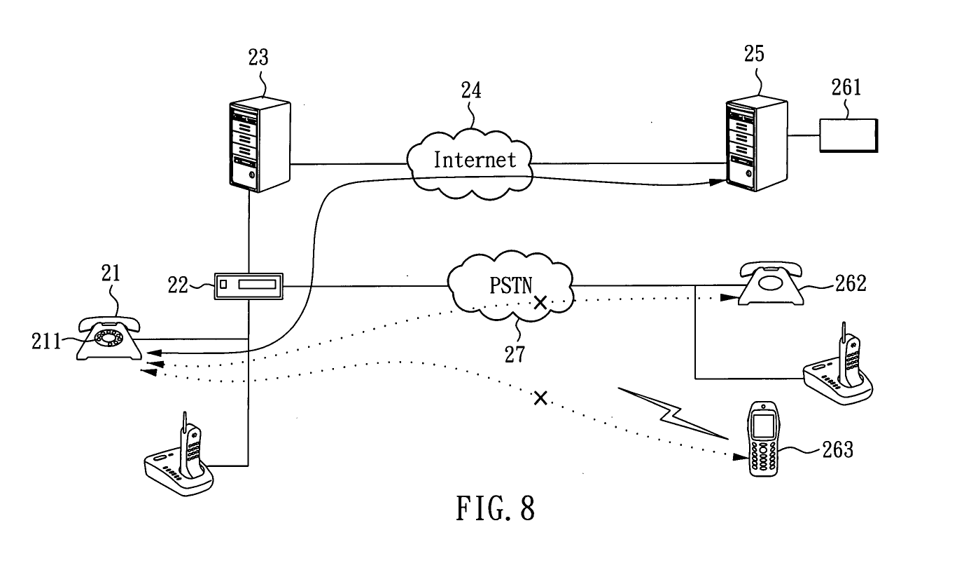

Relative to FIG. 5, FIGS. 7 and 8 illustrate the call box device redirecting a phone conversation from a PSTN call to a VoIP call. When predetermined key 211 is again being pressed, the DTMF signal generated therefrom is transmitted to SLIC module 223 of call box device 22 via the capacitor. The SLIC module 223 then outputs the control signal to the control module 225. The control module 225 then switches control unit 2224 based on the control signal so as to change the connection of first switch 2221. Hence, phone line socket 2211 breaks electrical connection with phone line socket 2212 and alternatively makes electrical connection with SLIC module 223. Also, control module 225 controls the connection of third switch 2223 such that SLIC module 223 is not electrically connected with phone line socket 2212 and LI module 224.

Since SLIC module 223 resumes electrical connection with caller terminal 21, caller terminal 21 can transmit audio data to receiver terminal 261 via SLIC module 223, control module 225, and computer device 23. Also, the voltage at the PSTN returns to 48V, thus the connection between caller terminal 21 and receiver terminal 261 is switched back to VoIP call. After users U1 and U2 resume in the VoIP call, the Internet quality monitor program still monitors the quality of Internet connection between caller terminal 21 and receiver terminal 261.

Referring to FIG. 3, if user U1 does not successfully establish VoIP connection with user U2, then user U1 can choose to press predetermined key 211 so as to switch to a PSTN call. If user U1 chooses not to press predetermined key 211, then the VoIP call is terminated between user U1 and user U2 (step S450). If user U1 does indeed press predetermined key 211, however, call box device 22 disconnects the VoIP call and switches the connection of the switches, such that SLIC module 223 of call box device 22 dials phone numbers stored on computer device 23 to establish a PSTN call (step S460) and users U1 and U2 carry on the conversation until the call has ended (step S465).

There are many factors that can contribute to the failure to establish the VoIP connection between user U1 and user U2. For instance, user U2 may have forgotten to or does not launch the VoIP phone application (not online), or user U2 is physically away from computer device 25, or user U2 for some reason cannot go online. Thus, as long as the above-described issues have not been solved, user U1 and user U2 can only remain in the PSTN call. If however, the above-described issues have been solved (e.g. user U2 can now go online), then user U1 can then choose to again press predetermined key 211 to quickly switch to a VoIP call via call box device 22. If user U1 indeed chooses to press predetermined key 211, then the PSTN connection established between users U1 and U2 is disconnected after call box device 22 performs the switching, and an alternative VoIP connection is established and users U1 and U2 can communicate in a VoIP call until the call has ended (steps S470, S405, S410, and S415).

The above-mentioned Internet quality program can be implemented in many ways, such as by: (1) using fixed audio characteristics to monitor Internet quality; (2) sampling the audio randomly to monitor Internet quality; or (3) using TCP/IP network traffic flow tools to monitor Internet quality.

When fixed audio characteristics are used to monitor Internet quality, both the computer devices of users U1 and U2 need to be installed of the Internet quality monitor program. The steps of monitoring are as described below: first, computer device outputs the predetermined digital audio stream samples through the Internet quality monitor program, in which the digital audio stream samples are fixed. Then, using the virtual sound card on the computer device, the predetermined digital audio stream samples are converted into audio signals and transmitted to the VoIP phone software to be subsequently transferred to the remote computer device via Internet. The virtual sound card on the remote computer device then converts the audio signals into digital audio stream samples, which are analyzed by the digital signal processor. If signals can be properly and correctly extracted, then it can be determined that the Internet quality is good. Conversely, if signals can not be properly and correctly extracted, it can be determined then the Internet quality is poor. For instance, computer device can send ten fixed DTMF audio signals to the remote computer device, and the Internet quality can then be determined based on whether the remote computer device can properly and accurately extract the ten DMTF audio signals.

During the testing of Internet quality by the random sampling of audio signals, the computer devices of both users U1 and U2 must be electrically connected to the call box device. The method of testing is as described below. First, at least one audio sample from the PSTN call is obtained by the method of random sampling. The audio sample is then converted by the SLIC module and control module of call box device into a PCM (Pulse Width Modulation) signal to be sent to the computer device. After then, Internet quality monitor program transmits the randomly sampled audio samples to the VoIP phone program, from which the samples are sent to the remote computer device via Internet. The virtual sound card on the remote computer device then converts and passes on the samples to the digital signal processor for analysis, and Internet quality can be determined based on whether the remote computer device can properly and accurately extract the audio signals. For instance, during the PSTN call, user speaks out the words of “test Internet” into the audio receiver. The “test Internet” audio signal can then be transmitted to the digital signal processor on the remote computer device via Internet, for determining the Internet quality by extracting the “test Internet” audio signal.

As mentioned, the TCP/IP network traffic flow tools can also be used to determine Internet quality. That is, the “Ping” command can be utilized to determine whether the Internet connection between the computer devices of users U1 and U2 is operating seamlessly. The “Trace Route” command can also be used to trace the line connection from the computer device of user U1 to the computer device of user U2.

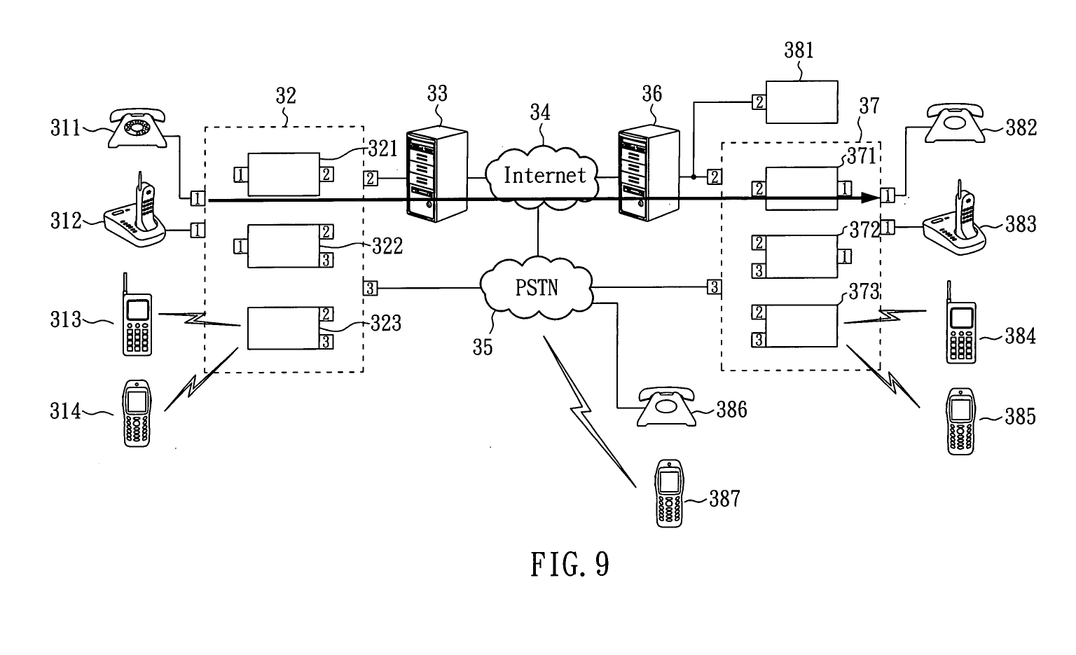

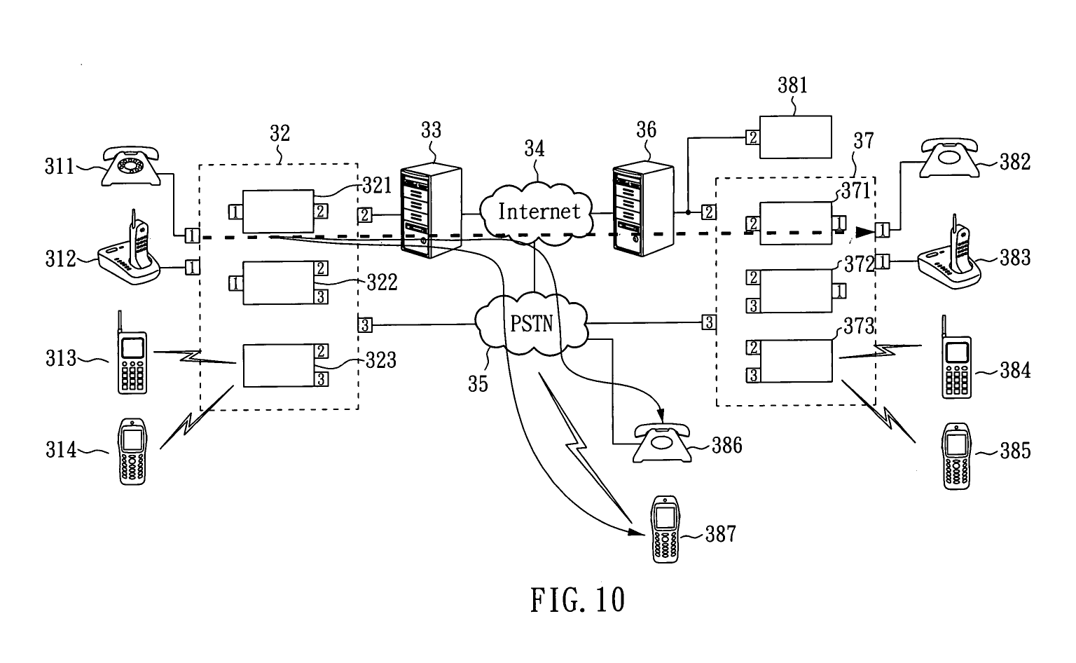

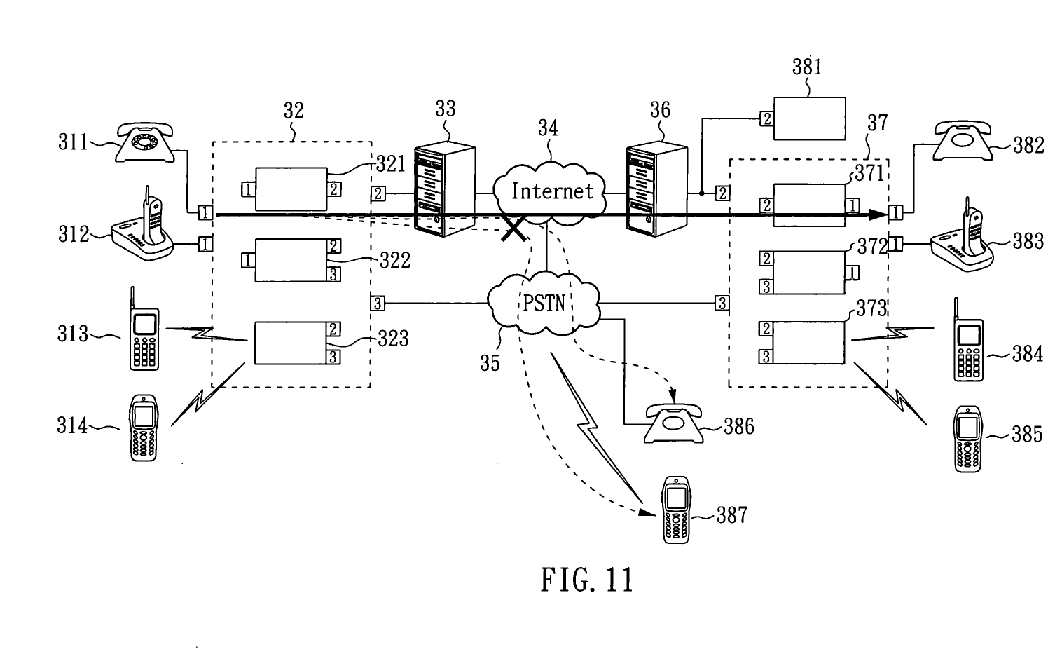

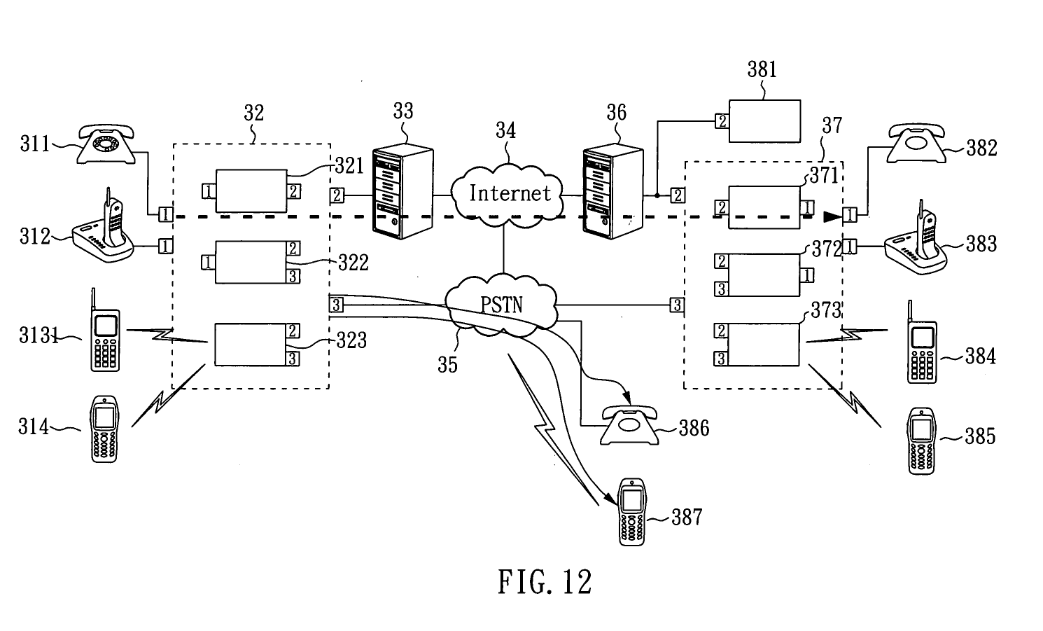

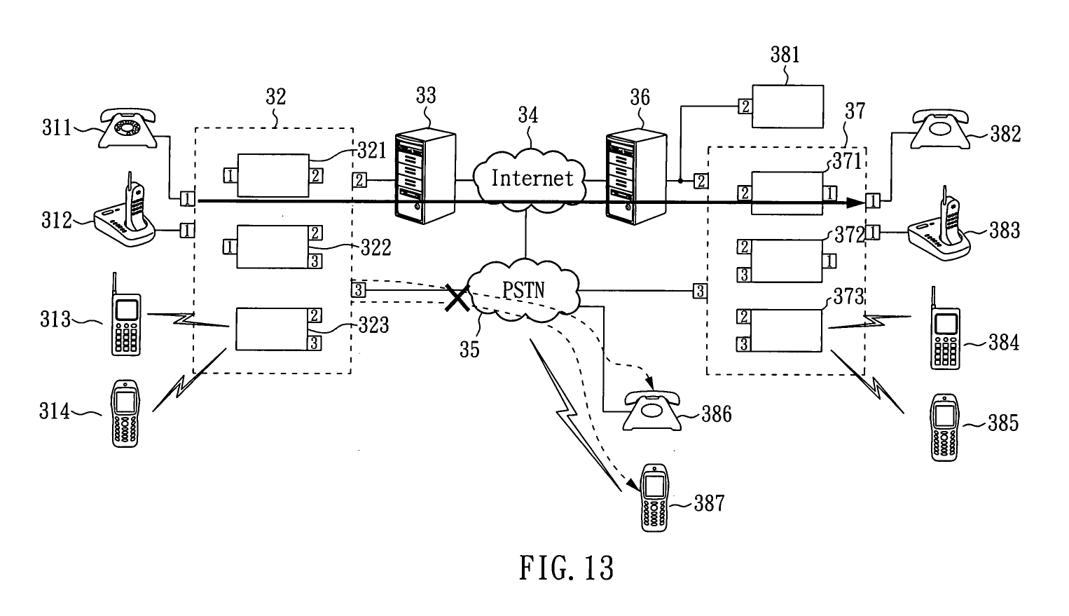

FIGS. 9-13 show illustrations of the second embodiment of the invention. FIG. 9 shows illustration of the caller terminal engaged in a call with the receiver terminal via the Internet. FIG. 10 shows illustration of the caller terminal engaged in a call with the receiver terminal first via Internet and then via the PSTN of the receiver terminal. FIG. 11 shows illustration of the caller terminal resuming the VoIP call with the receiver terminal. FIG. 12 shows illustration of the caller terminal engaging in a call with the receiver terminal via PSTN. FIG. 13 shows illustration of the call terminal resuming the VoIP call with the receiver terminal after terminating the PSTN call.

FIG. 9 includes caller terminals 311, 312, 313, and 314, call box devices 32 and 37, computer devices 33 and 36, Internet 34, PSTN 35, and receiver terminals 381, 382, 383, 384, 385.

In this embodiment, caller terminal 311 is a traditional phone; caller terminal 312 is a traditional indoor cordless phone set; caller terminal 313 is a digital cordless phone; and caller terminal 314 is a mobile phone with built-in Bluetooth module. In this embodiment, call box device 32 can be a compact call box device 321, a call box device 322, or a digital cordless phone base station 323.

Similarly, in this embodiment, call box device 37 can be a compact call box device 371, a call box device 372, or a digital cordless phone base station 373. In this embodiment, receiver terminal 381 is a headphone with microphone set; receiver terminal 382 is a traditional phone; receiver terminal 383 is a traditional indoor cordless phone; receiver terminal 384 is a digital cordless phone; receiver terminal 385 is a mobile phone with built-in Bluetooth module; receiver terminal 386 is a traditional phone; and receiver terminal 387 is a mobile phone.

Caller terminal 311 can be electrically connected to compact call box device 321, or to call box device 322. Caller terminal 312 can be electrically connected to compact call box device 321, or to call box device 322. Caller terminals 313 and 314 can be electrically connected to digital cordless phone base station 323.

Compact call box device 321, call box device 322 and digital cordless phone base station 323 all can be electrically connected with computer device 36. Furthermore, both call box device 322 and digital cordless phone base station 323 can be electrically connected with PSTN 35.

Similarly, receiver terminal 381 is electrically connected with computer device 36. Receiver terminal 382 can be electrically connected with compact call box device 371, or call box device 372. Receiver terminal 383 can be electrically connected to compact call box device 371, or call box device 372. Receiver terminals 384 and 385 can establish link with digital cordless base station 383. Receiver terminal 386 is electrically connected with PSTN 35. Receiver terminal 387 can establish link with PSTN 35.

Compact call box device 371, call box device 372, and digital cordless phone base station 373 can all be electrically connected with computer device 36. Call box device 372 and digital cordless phone base station 373 can both be electrically connected with PSTN 35. Computer devices 33 and 36 are electrically connected with Internet 34. Internet 34 is electrically connected with PSTN 35.

To better understand this embodiment of the invention, the operation of compact call box devices 321 and 371, and digital cordless phone base stations 323 and 373 are described.

Compact call box devices 321 and 371 are herein referred to as “SkyATA”. The SkyATAs are similar to call box devices 322 and 372 in interior circuit design but differ in functions. Compact call box devices 321 and 371 can only be electrically connected with computer devices 33 and 36, but not with PSTN 35; hence, compact call box devices 321 and 371 can only allow caller terminals 311 and 312 or receiver terminals 382 and 383 to make VoIP calls, but not PSTN calls directly.

Digital cordless phone base stations 323 and 373 differ from traditional indoor cordless phone base stations. In this embodiment, digital cordless phone base stations 323 and 373 can provide many functions. For instance: (1) user can receive/dial PSTN calls via the digital cordless phone base stations 323 and 373 and the phone sets thereof; (2) user can make use of a handheld device with built-in Bluetooth module (e.g. a mobile phone with built-in Bluetooth module) to communicate with other handheld devices with built-in Bluetooth modules via digital cordless phone base station 323 and 373 which are equipped with the functions of Bluetooth transfer; and (3) user can make use of the digital cordless phone or the handheld device with built-in Bluetooth module to dial VoIP calls via digital cordless phone base stations 323 and 373.

Digital cordless phone base stations 323 and 373 provide yet more functions, and the details are shown in Tables 1 and 2.

TABLE 1
Under VoIP call

| | | |
|---|---|---|
| Receiver terminal | 1. | Digital cordless phone base station directs the |
| ringing as a result of | | call in priority to the digital cordless phone; |
| an Incoming VoIP | 2. | If the digital cordless phone does not answer |
| call | | the call after a predetermined number of rings, |
| | | the digital cordless phone base station |
| | | forwards the incoming call to other traditional |
| | | phones (or mobile phones) on the PSTN, and |
| | | the digital cordless phone base station |
| | | preferably auto dials the predetermined |
| | | number stored on the application software in |
| | | the computer device; and |
| | 3. | If the digital cordless phone does not answer |
| | | the call after a predetermined number of rings, |
| | | the digital cordless phone base station can |
| | | forward the incoming call to the handheld |
| | | device with built-in Bluetooth module, and the |
| | | digital cordless phone base station preferably |
| | | auto dials the predetermined number stored in |
| | | the application software on the computer |
| | | device. |
| Receiver terminal | 1. | Digital cordless phone base station directs the |
| ringing as a result of | | call in priority to the digital cordless phone; |
| an incoming PSTN | 2. | If the digital cordless phone does not answer |
| call | | the call after a predetermined number of rings, |
| | | the digital cordless phone base station |
| | | forwards the incoming call to a VoIP call by |
| | | using the caller terminal which made the |
| | | PSTN call to dial the VoIP phone account |
| | | number. |
| | 3. | If the digital cordless phone does not answer |
| | | the call after a predetermined number of rings, |
| | | the digital cordless phone base station can |
| | | forward the incoming call to the handheld |
| | | device with built-in Bluetooth module, and the |
| | | digital cordless phone base station preferably |
| | | auto dials the predetermined number stored in |
| | | the application software on the computer |
| | | device. |
| Receiver terminal | 1. | Digital cordless phone base station directs the |
| ringing as a result of | | call in priority to the digital cordless phone; |
| an incoming call | 2. | If the digital cordless phone does not answer |
| made by a handheld | | the call after a predetermined number of rings, |
| device with built-in | | the digital cordless phone base station |
| Bluetooth module | | forwards the incoming call to a VoIP call by |
| | | using the caller terminal of the handheld |
| | | device with built-in Bluetooth module to dial |
| | | the VoIP phone account number; and |
| | 3. | If the digital cordless phone does not answer |
| | | the call after a predetermined number of rings, |
| | | the digital cordless phone base station can |
| | | forward the incoming call to other traditional |
| | | phones on the PSTN, and the digital cordless |
| | | phone base station preferably auto dials the |
| | | predetermined number stored in the |
| | | application software on the computer device, |
| | | or the caller terminal of the handheld device |
| | | with built-in Bluetooth module controls the |
| | | dialing of the PSTN number. |

TABLE 2
Not under VoIP call

| | | |
|---|---|---|
| Provided by digital | 1. | Dialing an ordinary PSTN call via the digital |
| cordless phone base | | cordless phone; and |
| station | 2. | Using a handheld device with built-in |
| | | Bluetooth phone to dial to other handheld |
| | | devices with built-in Bluetooth module. |
| Receiver terminal | 1. | Digital cordless phone base station directs the |
| ringing as a result of | | call first to the digital cordless phone; and |
| an incoming PSTN | 2. | If the digital cordless phone does not answer |
| call | | the call after a predetermined number of rings, |
| | | the digital cordless phone base station |
| | | forwards the incoming call to a handheld |
| | | device with built-in Bluetooth module, and the |
| | | digital cordless phone base station auto dials |
| | | the predetermined number. |
| Receiver terminal | 1. | Digital cordless phone base station directs |
| ringing as a result of | | the call in priority to the digital cordless |
| an incoming call by | | phone; and |
| a handheld device | 2. | If the digital cordless phone does not answer |
| with built-in | | the call after a predetermined number of |
| Bluetooth module | | rings, the digital cordless phone base station |
| | | can forward the incoming call to other |
| | | traditional phones on the PSTN, and the |
| | | digital cordless phone base station auto dials |
| | | the predetermined number, or the caller |
| | | terminal of the handheld device with |
| | | built-in Bluetooth module controls the |
| | | dialing of the PSTN number. |

The operating methods and functions of the digital cordless phone base stations 323 and 373 are shown in Table 1 and Table 2. To achieve above functions, digital cordless phone base stations 323 and 373 can include: computer transmission interface, control module, microprocessor, audio chip, multipath audio switch module, direct access arrangement module, Bluetooth module, cordless phone module, UART (Universal Asynchronous Receiver-Transmitter) switch module, and phone line sockets.

The above-mentioned transmission interface can be a USB (Universal Serial Bus) interface, for providing electrical connection between digital cordless phone base stations 323, 373 and computer devices 33 and 36. Phone lines sockets are for connecting digital cordless phone base stations 323 and 373 to PSTN 35. DAA module is configured in correspondence to the SLIC module on the PSTN side, such that the user on the Internet can emulate a call via the DAA module. The audio chip, multipath audio switch module, cordless phone module, and UART switch modules provide communication link between the digital cordless phone and other interfaces. Bluetooth module provides the functions of Bluetooth transmission and network. Control module and microprocessor controls the operation of the internal elements of digital cordless phone base stations 323 and 373.

In the above description, the operation and functions of the compact call box devices 321 and 371 and digital cordless phone base stations 323 and 373 were described. Next, still referring to FIG. 9, an example of the operation of caller terminals 311, 313, 313, and 314 using the switching method provided by the embodiment is described.

In the first embodiment, both examples of how user U1 makes use of the traditional phone and call box device to place a VoIP call to user U2 who answers the call with a headphone and a microphone, and of how user U1 quickly switches the VoIP call to a PSTN call by the pressing of a predetermined key have been described. Now, in this embodiment, the flexibility that users U1 and U2 have in being able to select different caller terminals, receiver terminals and call box devices is described.

Similar to the first embodiment, user U1 in this embodiment as shown in FIG. 9 can choose any one of the caller terminals 311, 312, 313, 314 to place a call. If user U1 decides on caller terminal 311 or caller terminal 312, then a PSTN call or a VoIP call can be made via compact call box device 321 or call box device 322; if user U1 decides on caller terminal 313 or caller terminal 314, then a PSTN call or a VoIP call can be made via digital cordless phone base station 323. User U2 then can decide on any one of receiver terminals 381, 382, 383, 384, and 385 to answer the VoIP call made by user U1.

In FIG. 10, while using caller terminal 311 or caller terminal 312, if user U1 experiences poor Internet quality or any other causes (e.g. user U2 is away from computer device 36) that may motivate user U1 to alternatively place a call via PSTN, then upon the pressing of the predetermined key (e.g. *key) user U1 can initiate the call switching via compact call box device 321 or call box device 322, and engage in a call with user U2 via a back-up communications path. For instance, even after the predetermined key is pressed, the VoIP connection between user U1 and user U2 is still sustained; that is, compact call box device 321 or call box device 322 operates such that user U1 can still use the existing VoIP phone to make calls, but the call from the VoIP phone is first directed to the remote PSTN (telephone company) near the second user U2 end such that the PSTN dials a PSTN call to user U2 (using the SkypeOut function provided by Skype). User U2 then can answer the PSTN call using one of the receiver terminals 382, 383, 384, 385, 386 and 387.

Similarly, if user U1 makes use of caller terminal 313 or caller terminal 314, then user U1 can through the pressing of a predetermined key (e.g. * key) on caller terminal 313 or caller terminal 314 switch the call via digital cordless phone base station 323. Thus, user U2 can answer the call using one of receiver terminal 382, 383, 384, 385, 386, and 387. Thus, through such scheme, user U1 can readily choose alternative methods to communicate with user U2 under poor Internet quality or other causes, thus giving user U1 great convenience and preventing the loss of important dialogues during a call.

FIG. 11 is a continuation in operation of FIG. 10. If the Internet quality returns to normal or user U2 returns to computer device 36 while user U1 engages in a call with user U2 through the switching method (dial to the remote PSTN through VoIP connection) shown in FIG. 10, user U1 can consider switching back to the original VoIP call. At this time, user U1 can press a predetermined key (e.g. number “0” key) such that call box device 32 switches the connection back to the sustained VoIP call, and disconnected from the remote PSTN. Thus, user U1 can thus make use of the Internet to engage in a call with user U2, thus greatly reducing phone costs.

Referring to FIG. 12, similar to FIG. 10, when the Internet quality is poor (or other causes exist) while making use of caller terminal 311 or caller terminal 312, user U1 can press a predetermined key (e.g. # key) on caller terminal 311 or caller terminal 312 to initiate the call switching via call box device 322, such that user U1 can engage in a call with user U2 via a back-up communications path. For instance, after the predetermined key is pressed, the VoIP connection between user U1 and user U2 is to be sustained; that is, call box device 322 operates such that user U1 can still make a call via the existing VoIP connection, but call box device 322 at this time dials the PSTN number or mobile phone number of user U2 stored on computer device 33 such that users U1 and U2 can engage in a call via PSTN. User U2 then can answer the PSTN call using one of the receiver terminals 386 and 387.

Similarly, if user U1 makes use of caller terminal 313 or caller terminal 314 instead, then user U1 can press a predetermined key (e.g. # key) on caller terminal 313 or caller terminal 314 to initiate the call switching via digital cordless phone base station 323. Thus, user U2 then can answer the call using one of receiver terminals 386 and 387. Thus, through such scheme, user U1 can readily choose alternative methods to communicate with user U2 under poor Internet quality or other causes, thus providing user U1 great convenience and preventing the loss of important dialogues during a call.

FIG. 13 is a continuation in operation of FIG. 12. If the Internet quality returns normal or user U2 returns to the computer device 36 while user U1 engages in a call with user U2 through the switching method (directly dial to user U2 via PSTN) shown in FIG. 12, user U1 can consider switching back to the original VoIP call. At this time, user U1 can press a predetermined key (e.g. number “0” key) such that call box device 32 switches the connection back to the sustained VoIP call, and disconnects from PSTN. Thus, user U1 can make use of the Internet to engage in a call with user U2, thereby greatly reducing phone costs.

As mentioned above, the invention provides a method of quick switching between a VoIP call and a PSTN call. A VoIP call can be sustained by a user through a simple act of operation, such as through the pressing of a predetermined button, and the call box device auto dials the traditional phone number of the receiver so as to switch the VoIP call to PSTN call, thus maintaining call quality. The invention also provides an Internet monitoring scheme. When the user (caller) and the receiver engage in a PSTN call, the status of Internet quality is automatically monitored. If the Internet quality returns to a good condition, then the user is informed of whether to switch back to the VoIP call in order to save costs.

Although the present invention has been explained in relation to its preferred embodiment, it is to be understood that many other possible modifications and variations can be made without departing from the spirit and scope of the invention as hereinafter claimed.

What is claimed is:

1. A method of switching between a VoIP call and a traditional call, applied between a caller terminal and a receiver terminal, the caller terminal being electrically connected with a call box device, the call box device being electrically connected with a first computer device, the receiver terminal being electrically connected with a second computer device, both the first computer device and the second computer device being connected to an Internet, the method of switching comprising:
(A) establishing a VoIP connection between the caller terminal and the receiver terminal;
(B) monitoring the quality of Internet connection between the caller terminal and the receiver terminal if the VoIP connection is successfully established between the caller terminal and the receiver terminal;
(C) if the quality of Internet connection between the caller terminal and the receiver terminal is found to be poor, switching the caller terminal by the call box device after a first predetermined key on the caller terminal is pressed, such that the caller terminal and the receiver terminal engage in a call via a back-up communications path; and
(D) if the quality of Internet connection between the caller terminal and the receiver terminal returns to a good condition, switching the caller terminal by the call box device after a second predetermined key on the caller terminal is pressed, such that the caller terminal and the receiver terminal engage in the VoIP call via the Internet.

2. The method as claimed in claim 1, wherein the VoIP connection established between the caller terminal and the receiver terminal is still sustained after the call box device switches the caller terminal in step (C).

3. The method as claimed in claim 1, wherein the call box device dials a phone number to alternative phone devices associated with the receiver terminal when the call box device switches the caller terminal in step (C).

4. The method as claimed in claim 1, wherein the first computer device displays a poor Internet quality message if the quality of Internet connection between the caller terminal and the receiver terminal is found to be poor in step (C).

5. The method as claimed in claim 1, wherein the quality of Internet connection between the caller terminal and the receiver terminal is continued to be monitored after the call box device switches the caller terminal in step (C).

6. The method as claimed in claim 5, wherein the first computer device displays a good Internet quality message when the quality of Internet connection between the caller terminal and the receiver terminal returns normal.

7. The method as claimed in claim 5, wherein the VoIP connection established between the caller terminal and the receiver terminal is still sustained after the call box device switches the caller terminal, and the VoIP connection is resumed after the second predetermined key on the caller terminal is pressed if the quality of Internet connection between the caller terminal and the receiver terminal returns normal.

8. The method as claimed in claim 7, wherein the call box device first disconnects a PSTN (Public Switched Telephone Network) connection on the caller terminal.

9. The method as claimed in claim 7, wherein the call box device switches the caller terminal to the VoIP connection so as to resume the previously sustained VoIP connection.

10. The method as claimed in claim 1, wherein the caller terminal establishes a PSTN connection via the call box device after the first predetermined key on the caller terminal is pressed on the caller terminal if the VoIP connection is not successfully established between the caller terminal and the receiver terminal in step (B).

11. The method as claimed in claim 10, wherein the call box device first disconnects the VoIP connection before the call box device switches the caller terminal to the PSTN connection.

12. The method as claimed in claim 10, wherein the call box device switches the caller terminal, if the second predetermined key on the caller terminal is pressed, by first disconnecting the PSTN connection of the caller terminal which establishes the VoIP connection again via the Internet.

13. The method as claimed in claim 10, wherein the call box device is electrically connected with the PSTN.

14. The method as claimed in claim 1, wherein in step (C), the back-up communications path is the path from which the caller terminal establishes a phone conversation with the receiver terminal via the PSTN.

15. The method as claimed in claim 1, wherein in step (C), the back-up communications path is the path from which the caller terminal first is directed to a remote PSTN near the receiver terminal via a VoIP connection such that the PSTN dials a PSTN call to the receiver terminal to establish a phone conversation.
